(19) United States
(12) Patent Application Publication
(10) Pub. No.: US 2018/0370450 A1
(43) Pub. Date: Dec. 27, 2018

(54) PORTABLE RACK SYSTEM

(71) Applicant: Ri-Go Lift Truck Ltd., Concord (CA)

(72) Inventor: Matthew SLOCOMBE, Churchill (CA)

(21) Appl. No.: 15/982,100

(22) Filed: May 17, 2018

Related U.S. Application Data
(60) Provisional application No. 62/507,446, filed on May 17, 2017.

(51) Int. Cl. B60R 9/06; B60P 3/40; B60R 11/00

(52) U.S. Cl. CPC B60R 9/06; B60P 3/42; B60R 11/00; B60P 3/40

(57) ABSTRACT

Portable rack systems for transporting elongate members such as pipes, bars, or beams includes a frame assembly having a base, one or more arms for supporting the elongate members in a preferably substantially horizontal orientation; and fittings or other means for cooperating with lift forks or other devices for lifting and transporting the assemblies, including when wholly or partially loaded with elongate members,so that the assemblies can easily be moved and placed on a bed, floor, or deck of a vehicle such as a truck, rail car, or ship for transportation. In various embodiments, straps, chains, and other devices for releasably but effectively securing elongate members to the racks, and the racks to the floor or deck of the transportation vehicle, are provided,

### Cross-Reference to Related Applications

This application claims all benefit, including priority, of U.S. Provisional Patent Application Ser. No. 62/507,446, filed 17 May 2015 and entitled Portable Rack System, the entire contents of which are incorporated herein by this reference.

### BACKGROUND OF THE INVENTION

### Technical Field

The invention relates generally to racks for storing and transporting elongate members, and more particularly to portable racks for storing and transporting elongate members, such as pipes, rods, beams, posts, and the like.

### Related Art

When needed to transport elongate members, such as conduits, pipes, structural beams, rods, posts and the like, typically the elongate members are loaded individually onto a bed, deck, floor, or other surface or structure of a trailer, truck, railroad car, ship, boat, aircraft, or shipping container, etc., and then transported to the desired location, and then removed individually for use. The process of loading and unloading the elongate members can be labor intensive and time consuming. In addition, while transporting the elongate members, depending on how they are placed on the vehicle, they can be subjected to unwanted movement and damage, wherein the damage can result to the elongate members and/or to the vehicle. Further, if the elongate members are permitted to move while being transported, this can present a safety concern.

Portable rack systems constructed in accordance with various aspects and embodiments of the invention overcome at least those problems mentioned above. Moreover, those of ordinary skill in the relevant arts will doubtless recognize further benefits of the novel portable rack system disclosed herein.

### SUMMARY OF THE INVENTION

In various aspects and embodiments the invention provides portable rack systems for transporting elongate members such as pipes, bars, or beams includes a frame assembly having a base, one or more arms for supporting the elongate members in a preferably substantially horizontal orientation; and fittings or other means for cooperating with lift forks or other devices for lifting and transporting the assemblies, including when wholly or partially loaded with elongate members, so that the assemblies can easily be moved and placed on a bed, floor, or deck of a vehicle such as a truck, rail car, or ship, or within a shipping container, for transportation. In various embodiments, straps, chains, and other devices for releasably but effectively securing elongate members to the racks, and the racks to the floor or deck of the transportation vehicle, are provided.

In accordance with one aspect of the invention, a portable rack system for transporting elongate members is provided. The portable rack system includes a frame assembly having a base; at least one support member extending upwardly from the base, and a plurality of arms extending laterally outwardly from the at least one support member. The plurality of arms include at least a pair of arms spaced laterally in mirrored relation from one another to provide coplanar surfaces for supporting the elongate members. The frame assembly further includes at least one receptacle, configured for receipt of a pair of forks of a fork lift, to facilitate transporting the portable rack assembly.

In accordance with another aspect of the invention, the base can include a pair of elongate base members spaced laterally in mirrored relation from one another with a plurality of cross brace members operably securing the base members in fixed relation with one another.

In accordance with another aspect of the invention, the at least one support member can include a pair of support members, with a separate one of the support members extending upwardly from a separate one of the base members, with at least one of the cross brace members being fixed to the pair of support members.

In accordance with another aspect of the invention, the plurality of arms can include a plurality of pairs of arms, with each pair of arms being spaced laterally in mirrored relation from one another to provide coplanar surfaces for supporting the elongate members.

In accordance with another aspect of the invention, at least some of the pairs of arms can extend from a first side of the pair of support members and at least some of the pairs of arms can extend from a second side of the pair of support members opposite the first side, thereby enhancing the carrying capacity of the assembly and providing a symmetrically balanced assembly.

In accordance with another aspect of the invention, the pairs of arms extending from the first side of the pair of support members are in mirrored relation with the pairs of arms extending from the second side of the pair of support members, thereby providing the assembly with a well-balanced, symmetrical or substantially symmetrical structure.

In accordance with another aspect of the invention, the at least one receptacle can be fixed to at least one of the cross brace members, thereby making manufacture economical and efficient.

In accordance with another aspect of the invention, the at least one receptacle can include a plurality of receptacles spaced in predetermined relation from one another to receive standard forks of a standard fork lift.

In accordance with another aspect of the invention, the plurality of arms can be configured to be adjustable such that they can be positioned in a plurality of different positions along a length of the at least one support member.

In accordance with another aspect of the invention, the plurality of arms can be inclined to extend away from the at least one support member in an upward direction from the base to facilitate preventing the elongate members being carried thereon from inadvertently falling off the arms.

In accordance with another aspect of the invention, the system can further include a separate retainer member operably attached to each of the plurality of arms, with the retainer members extending upwardly from the arms to provide a barrier to the elongate members against falling off the arms.

In accordance with another aspect of the invention, the retainer members can be adjustable to be positioned in a plurality of different positions along a length of the arms, thereby allowing the retainer members to be brought into close proximity/abutment with the elongate members to prevent the elongate members from shifting while being transported.

In accordance with another aspect of the invention, the system can further include an integral cover assembly operably attached to the frame, with the cover assembly including a flexible barrier member that is both extendable to cover and protect the elongate members supported on the arms and retractable to allow access to the elongate members being carried on the arms.

In accordance with further aspects, racks in accordance with any embodiments of the invention can comprise various forms of retainer for devices, including for example tie-down chains and straps, to secure either or both of elongage members to the racks, and to secure the racks to beds, decks, floors, or other surfaces of trailers, trucks, railroad cars, ships, boats, aircraft, shipping containers, etc., in order to secure the racks and/or elongate members from shifting, damage, and other problems during transportation.

### BRIEF DESCRIPTION OF THE DRAWINGS

These and other aspects, features and advantages of the present invention will become more readily appreciated when considered in connection with the following detailed description of presently preferred embodiments and best mode, appended claims and accompanying drawings, in which:

FIGS. 1 and 2 are perspective views of vehicles transporting embodiments of portable rack systems in accordance with the disclosure;

FIG. 3 is a side view of the portable rack system of FIG. 1 or 2, shown with elongate members loaded or otherwise disposed thereon;

FIG. 4 is a front view of the portable rack system of FIG. 1 or 2;

FIG. 5A is a side view of a support member of the portable rack system of FIG. 1 or 2;

FIG. 5B is a front view of the support member of FIG. 5A;

FIG. 6A is a side view of a base member of the portable rack system of FIG. 1 or 2;

FIG. 6B is a front view of the base member of FIG. 6A;

FIG. 7A is a side view of an arm of the portable rack system of FIG. 1 or 2; and

FIG. 7B is a front view of the arm of FIG. 7A.

FIGS. 8 and 9 are perspective views of a vehicle transporting an embodiment of a portable rack system in accordance with various aspects of the invention.

### DETAILED DESCRIPTION OF PRESENTLY PREFERRED EMBODIMENTS

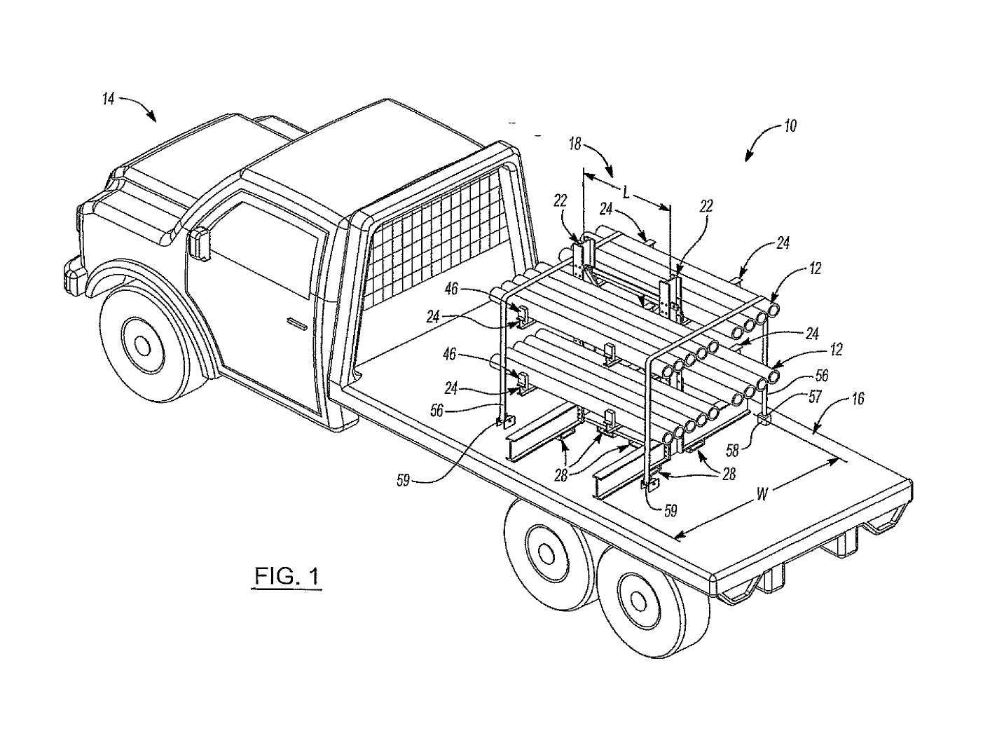

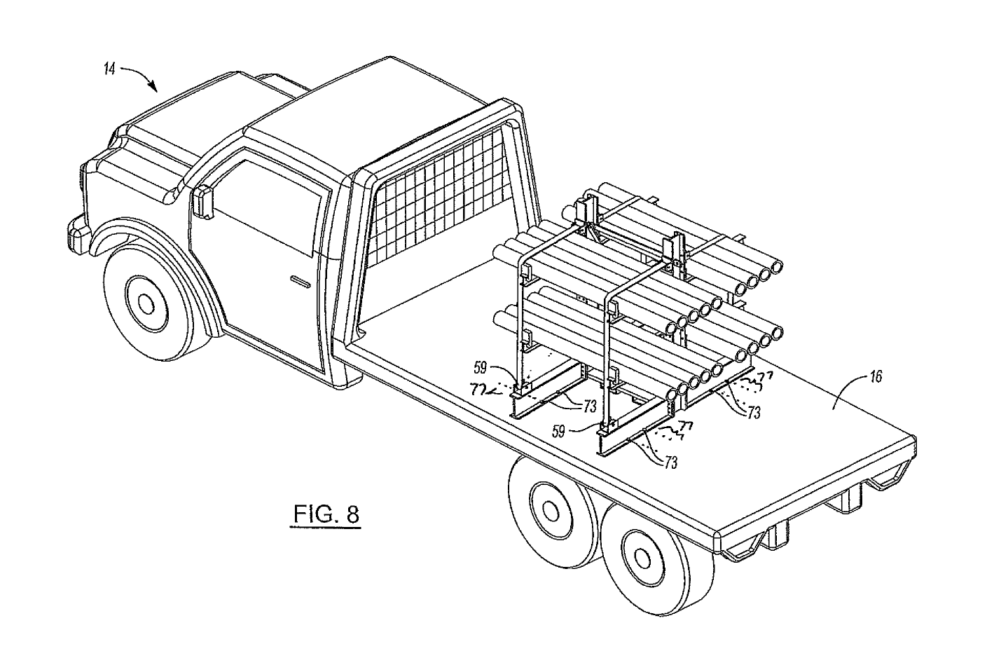

Referring in more detail to the drawings, FIGS. 1-4 illustrate a portable rack system 10 constructed in accordance with one aspect of the invention for transporting and stowing elongate members 12 thereon, such as pipes, rods, posts, beams and the like. The portable rack system, referred to hereafter simply as system 10, may be sized to be loaded safely and conveniently onto one or more types, makes, models, or classes of vehicle 14, such as a bed, deck, floor or other surface 16 of a trailer, truck, railroad car, ship, boat, or aircraft, shipping container, or other vehicle 14, including for example a bed of a pickup truck, by way of example and without limitation. Of course, it is to be recognized that the system 10 can be sized to be transported on any desired vehicle or type of vehicle. In the embodiments shown, the system 10 includes a frame assembly 18 having a base 20; at least one upstanding column, referred to hereafter as support member(s) 22, extending upwardly from the base 20, and a plurality of arms 24 (FIGS. 1-3, 7A and 7B) extending laterally outwardly and optionally upwardly away from the support member 22. The plurality of arms 24 can include at least a pair of arms 24 spaced laterally in mirrored relation from one another to provide substantially horizontal or otherwise substantially coplanar surfaces 26 for supporting the elongate members 12 in a substantially horizontal orientation, in order, for example, to minimize the possibility of items sliding off when the rack, or a vehicle on which the rack is loaded, is accelerated, decelerated, etc. The frame assembly 18 further includes at least one receptacle, receiver, or other device 28, shown in FIG. 4 as a pair of receptacles configured for receipt of a pair of forks of a fork lift; or other lifting devices, including for example lugs or hands (not shown) to facilitate lifting and otherwise transporting the portable rack system 10.

Receptacles, receivers, or other receiving fittings or devices 28 can be formed as integral parts of, or otherwise attached to (for example, by welding) any one or more parts of a base 20, or other portions of a rack 10, of suitable strength and configuration for accommodating lift forks or other lifting or carrying device(s); and they may be disposed to as to enable a fork lift or other transportation device to approach the rack 10 and lift, drag, or otherwise move it from any desired direction or orientation, when loaded or unloaded. For example, as shown in FIG. 1, fork receptacles 28 can be provided so that the rack 10 can be lifted by a fork lift or other device approaching the rack either from the side, by means for example of transverse-oriented receptacles 28a, or from the front or rear, by means of axially-oriented receptacles 28b. Alternatively, or in addition, lugs or other lifting devices 29 can be provided for lifting and transporting rack(s) 10 by means of interior or exterior cranes, lifts, or other devices, as shown for example in FIG. 1.

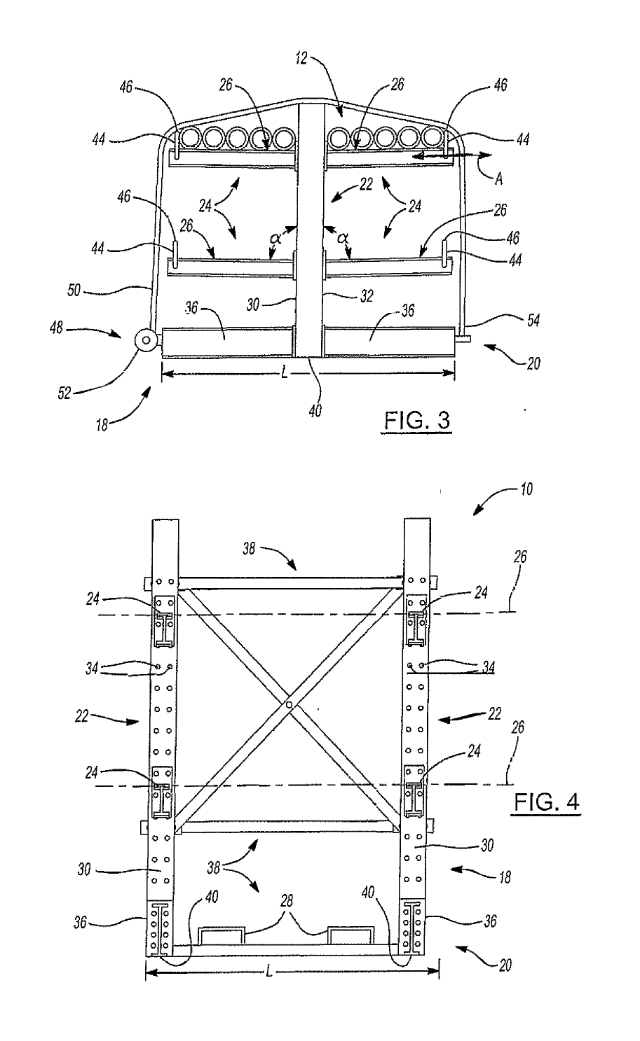

Support member(s) 22 and base member 20 are shown as configured in pairs of support members 22 spaced axially from one another to define a width L (FIG. 1) or laterally to define a width W (FIG. 4) of the rack assembly 10. As shown in FIG. 3, the support members 22 can be provided to extend along a midsection of the system 10, such that half a width W of the system 10 extends from opposite sides 30, 32 of the support members 22. Alternatively, in some embodiments support members 22 may be provided inclined pairs 25, as shown in FIG. 1, to faun an ‘A’-frame or other suitable configuration. As will be understood by those skilled in the relevant arts, such configurations can enhance the strength and stability of rack(s) 10 or portions thereof.

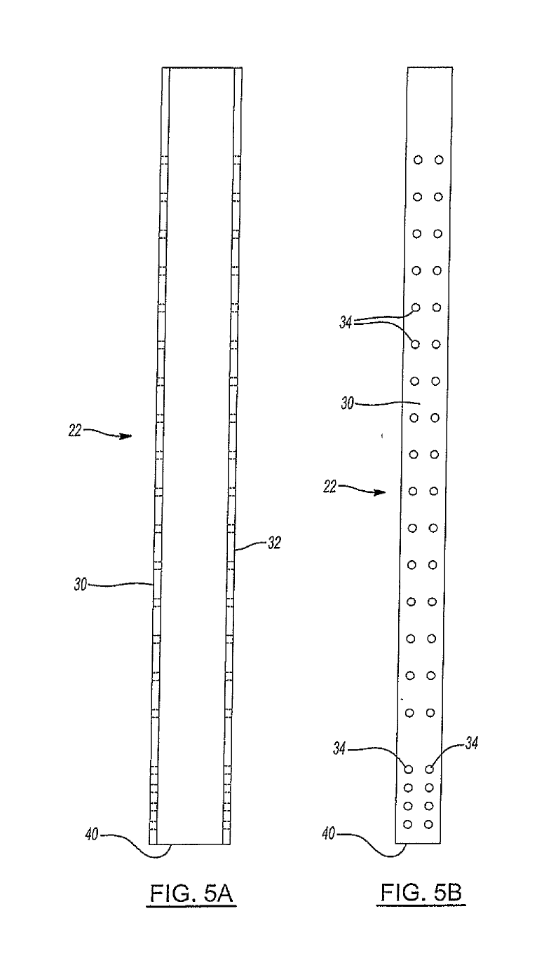

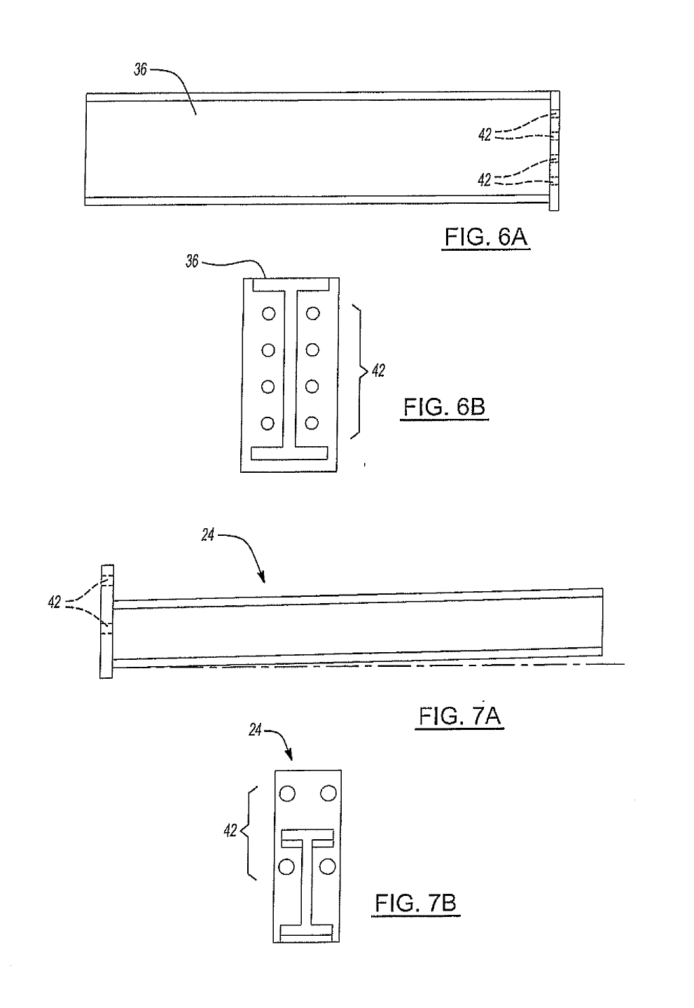

To allow for modular assembly of the system 10, opposite sides 30, 32 of support member(s) 22 can be provided with first attachment features, shown, by way of example and without limitation, as through openings 34 (FIGS. 4 and 5B, wherein only a pair of the plurality of through openings 34 are identified to avoid complicating the view with excessive lines and numbers), such that the base 20, including a plurality of base members 36 (FIGS. 3, 4, 6A and 6B), and arms 24 can be releasably attached thereto via second attachment features 42, such as bolts, protrusions, hooks, and the like. Through openings 34 can be configured in spaced relation from one another as desired to allow the arms 24 to be adjusted and spaced vertically from one another in the desired positions. Further yet, openings 34 configured for attachment of base members 36 can allow for adjustment of the base members 36 relative to one another, thereby allowing the system 10 to be securely placed on a surface that is other than planar, such as having undulations or steps, by way of example and without limitation.

As will be appreciated by those skilled in the relevant arts, use of standard size openings 24, 34, 42, etc., and/or other attachment devices, enables use of interchangeable arms and base members 40, 36, etc., such that rack(s) 10 can be easily repairable and can, through for example the use of arms and base members 40, 36, of varying length, enable rack(s) 10 of varying lengths L and widths W to be assembled quickly and effectively.

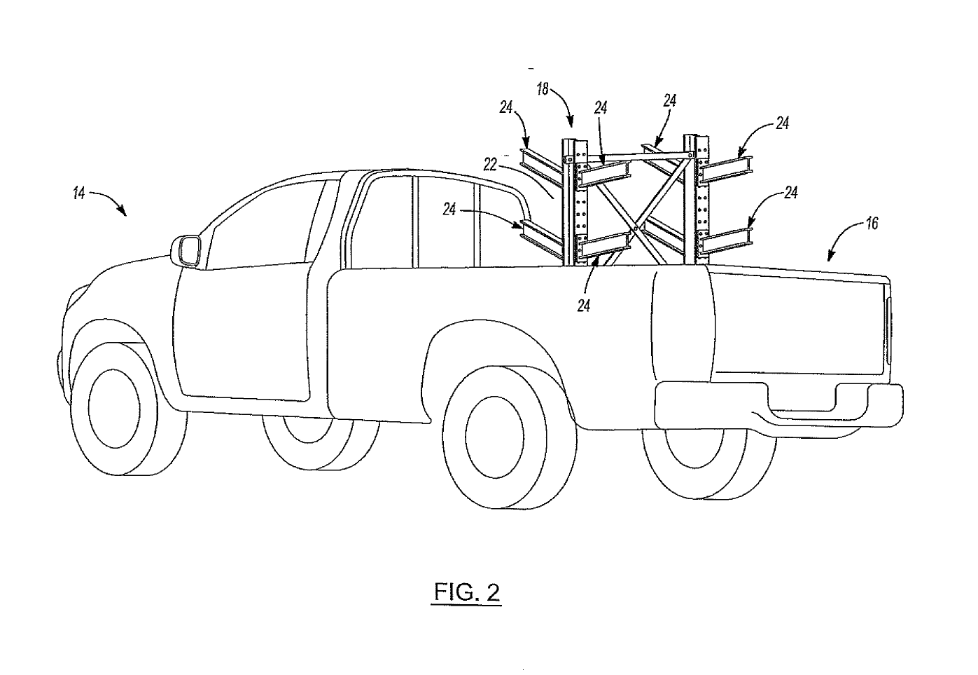

Support members 22 can be fixed or releasably fixed to one another via one or more cross brace members 38, shown as a plurality of cross brace members as shown in FIGS. 2 and 4. Some of the cross brace members, referred to hereafter simply as cross members 38, are shown as forming an X-pattern configuration with one another, though any suitable arrangement of the cross members 38 is contemplated herein, including a latter-like configuration, such that the cross members 38 extend horizontally rather than in inclined, crossing relation, as shown. A lowermost cross member 38 is shown as extending horizontally adjacent ends 40 of the support members 22, such that the lowermost cross member 38 is shown as forming a lowermost surface of the system in generally coplanar relation with axially-oriented base members 36.

In the embodiments shown, base 20 includes a plurality of elongate base members 36, with a first pair of the base members 36 shown as being attached to one support member 22 and a second pair of the base members 36 shown as being attached to the other support member 22. The separate pairs of base members 36 can be releasably attached to the opposite sides 30, 32 of the separate support members 22 via second attached features, shown as protrusions 42 sized for releasable locking receipt in the through openings 34, such that the pairs of support members 36 are spaced laterally in mirrored relation from one another. It is to be recognized that the base members 36 could be formed as single pieces of material rather than a separate pairs, if desired. However, the separate pairs facilitate modular construction.

Arms 24 can be provided as plurality(ies) of pairs of arms 24, with each of a given pair of arms 24 being spaced laterally in mirrored relation from one another to provide a plurality of coplanar surfaces 26 for supporting the elongate members 12. The arm 24 can be individually attachable to their respective support member 22 via the attachment features, shown as protrusions 42, sized for releasable locking receipt in the through openings 34 of the support members 22. As such, the arms 24 can be individually adjusted and releasably locked to the support members 22 in the desired locations. The arms 24 can be configured to extend from the sides 30, 32 of the pair of support members 22 in inclined fashion to extend away from the support members 22 in an upward direction from the base 20 to form an included angle of inclination a that is less than 90 degrees. The inclination of the arms 24 causes the elongate members 12 to migrate toward the support members 22 during transportation, and thus, inhibits the elongate members 12 from inadvertently falling off the arms 24.

To further facilitate retaining stored or supported elongate members 12 on arms 24, integral or attachable retainer members 44 (FIG. 3) can be provided on some or all the plurality of arms 24, such that a flange 46 of the retainer members 44 is provided, extending upwardly from the arms 24 to provide a barrier to the elongate members 12 from sliding, rolling, or otherwise falling or otherwise passing off the end of one or more arms 24. The retainer members 24 can be removable and/or otherwise adjustable (see arrow A) along a length of the arms 24 to be positioned in a plurality of different positions along a length of the arms 24, thereby being able to be positioned in snug fit with the elongate members 12 to inhibit lateral movement of the elongate members 12 between the support members 22 and the retainer members 44.

In various aspects and embodiments, portable rack systems 10 in accordance with the invention further include cover assembly(ies) 48 (FIG. 3) operably attached to the frame assembly 18, such that a plastic, fabric, or other cover membrane can be disposed to partially or entirely shroud, cover, or protect one or more elongate members disposed on one or more sets of arms 26. Such a cover assembly 48 can, for example, include a cover, also referred to as barrier member or membrane 50, that is both extendable to cover and protect the elongate members 12 supported on the arms 24 and retractable to allow access to the elongate members 12 on the arms 24. The barrier member 50 can, for example, be wrapped about a spool in a housing 52, wherein the spool can be spring biased to maintain the barrier member 50 in its wrapped state, whereupon the barrier member 50 can be readily pulled outwardly from the housing 52 to cover the arms 24 and elongate members 12 thereon. A free end 54 of the barrier member 50 can be releasably fixed to remain disposed about the elongate member 12 via any suitable fastener device. Of course, when desired, the barrier member 50 can be released from its fastened state and allowed to recoil into its wrapped state under the bias of a spring member when desired. Moreover, the cover assembly 48 can be removably attached to the rack 10, such that the entire assembly may be removed for repair, replacement, cleaning, storage, etc.

In various aspects and embodiments, portable rack systems 10 in accordance with the invention further include provisions for enabling efficient, positive securement of elongate members placed on arms 26 to racks 10, so that the elongate members are prevented from bouncing, sliding, or otherwise becoming dislodged from their placement, and spilling off the rack. Such advantages may, for example, be provided through provision of retainer or tie-down chains, or straps 56 adapted to hold elongate members 12 to individual arms 24, or to pair or other sets of arms 24, as shown in FIG. 8. For example, in various embodiments of the invention rack(s) 10 comprise tie-down straps provided on rollers, fixedly or removably attached to any or all of base members 20, arms 24, etc., with corresponding hooks, catches, or retainers provided at other locations on members 20, arms 24, etc., to removably secure free ends of the straps when the straps are used to restrain elongate members 12 on the rack assembly 10. Thus, as shown in FIGS. 1 and 8, in various aspects and embodiments the invention provides portable rack systems or assemblies 10, including at least one retainer 58 for at least one tie-down strap, cable, or chain 56, which may include one or more turnbuckles or other length-adjusting means, the retainer 58 configured to releasably secure at least one end 57 of a tie-down strap and thereby restrain at least one elongate member 12 disposed upon at least one arm 24 of said portable rack system 10. Using a variety of commercially-available products, retractable tie-down straps can be provided on spring-biased, ratcheted, or other types of roller devices 59.

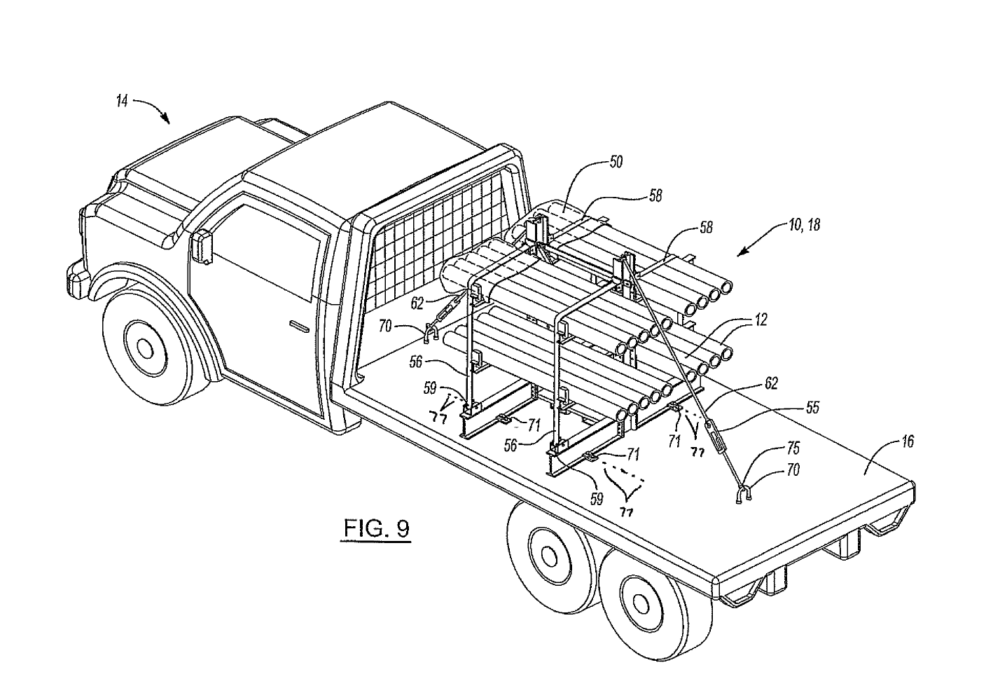

In various aspects and embodiments, portable rack systems 10 in accordance with the invention further include provisions for releaseably securing racts 10 in accordance with the disclosure to beds, floors, decks, or other surfaces of trucks, train cars, aircraft, shipping containers, or other vehicles, so that the rack assemblies 10 do not slide, bounce, or otherwise move or shift during transportation. Such provisions can for example include clamps 71, bolts 73, lugs 70, hooks 75, screws, straps, or other means 70 configured to cooperate with base members 20, supports 22, or other portions of assemblies 10; such as tie-down straps, cables or chains 62, with or without turnbuckles 55 or other tightening mechanisms, and/or and clamps 64 shown for example in FIGS. 1 and 9. Clamps 71 and bolts 73 can be configured for engagement of threaded holes 77, which may be provided in surface 16 in any desired configurations. Thus, assemblies 10 in accordance with such aspects and embodiments can comprise one or more fittings adapted for releasable attachment of the rack system 10 to a surface 16 of a vehicle.

In accordance with a further aspect of the disclosure, with the system 10 being constructed in modular fashion, the arms 24 and base members 36 can be readily detached from the support members 22 to facilitate storage of the system 10. It is to be recognized that the components of the frame assembly 18, including the base 20, support member 22 and arms 24 can be constructed of any suitably rigid, high strength material, including metal, plastic, reinforced plastic, composite, and the like. Further, it is to be recognized that the frame components can be solid and/or hollow, as desired, wherein hollow components provide an enhanced benefit of being reduced in weight relative to solid components.

Many modifications and variations of the present invention are possible in light of the above teachings. It is, therefore, to be understood that the invention may be practiced otherwise than as specifically described, and that the scope of the invention is defined by any ultimately allowed claims.

What is claimed is:

1. A portable rack system for transporting elongate members, comprising a frame assembly having:
a base;
at least one support member extending upwardly from said base;
a plurality of arms extending laterally outwardly from said at least one support member, said plurality of arms including at least a pair of arms spaced laterally in mirrored relation from one another to provide coplanar surfaces for supporting the elongate members; and
at least one receptacle configured for receipt of a pair of lift forks to facilitate transporting the portable rack system.

2. The portable rack system of claim 1, wherein said base includes a plurality of elongate base members spaced laterally in mirrored relation from one another with a plurality of cross brace members operably securing said base members in fixed relation with one another.

3. The portable rack system of claim 2, wherein said at least one support member includes a pair of support members with a separate one of said support members extending upwardly from a separate one of said base members, with at least one of said cross brace members being fixed to said pair of support members.

4. The portable rack system of claim 3, wherein said plurality of arms includes a plurality of pairs of arms, each of said pair of arms being spaced laterally in mirrored relation from one another to provide coplanar surfaces for supporting the elongate members.

5. The portable rack system of claim 4, wherein said at least some of said pairs of arms extend from a first side of said pair of support members and at least some of said pairs of arms extend from a second side of said pair of support members opposite said first side.

6. The portable rack system of claim 5, wherein said pairs of arms extending from said first side of said pair of support members are in mirrored relation with said pairs of arms extending from said second side of said pair of support members.

7. The portable rack system of claim 2, wherein said at least one receptacle is fixed to at least one of said cross brace members.

8. The portable rack system of claim 7, wherein said at least one receptacle includes a plurality of receptacles.

9. The portable rack system of claim 1, wherein said plurality of arms are adjustable to be positioned in a plurality of different positions along a length of said at least one support member.

10. The portable rack system of claim 1, wherein said plurality of arms are inclined to extend away from said at least one support member in an upward direction from said base.

11. The portable rack system of claim 1, further including a separate retainer member operably attached to each of said plurality of arms, said retainer members extending upwardly from said arms.

12. The portable rack system of claim 11, wherein said retainer members are adjustable to be positioned in a plurality of different positions along a length of said arms.

13. The portable rack system of claim 1, further including a cover assembly operably attached to said frame, said cover assembly including a barrier member that is both extendable to cover and protect the elongate members supported on said arms and retractable to allow access to the elongate members on said arms.

14. The portable rack system of claim 1, further including at least one retainer for at least one tie-down strap, the retainer configured to releasably secure at least one end of a tie-down strap and thereby restrain at least one elongate member disposed upon at least one arm of said portable rack system.

15. The portable rack system of claim 1, further comprising at least one retractable tie-down strap device, the tie-down device configured to restrain at least one elongate member disposed upon at least one arm of said portable rack system.

16. The portable rack system of claim 1, further comprising at least one fitting adapted for releasable attachment of the rack system to a surface of a vehicle.
